(19) United States
(12) Patent Application Publication
(10) Pub. No.: US 2004/0109193 A1
(43) Pub. Date: Jun. 10, 2004

(54) Image forming device having a transmission control and method of operating an image forming device

(76) Inventors: Brett Smith, Boise, ID (US); James M. Schott, Boise, ID (US); Rick Rothwell, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/310,725

(22) Filed: Dec. 4, 2002

(51) Int. Cl. G06F 11/30; G06F 3/12; G06F 15/00

(52) U.S. Cl. 358/1.14; 710/19; 710/16; 710/18; 358/1.15

(57) ABSTRACT

An image forming device and method of operating an image forming device are disclosed, and which includes a transmission control which is configured to selectively transmit at least one digital image having information regarding the image forming device and its operative state to a remote location.

### FIELD OF THE INVENTION

The invention generally relates to image forming devices and more particularly to an apparatus and method for transmitting information regarding the operative state and configuration of the image forming device to a remote location.

### BACKGROUND OF THE INVENTION

Most image forming devices, such as facsimile machines, printers and copiers, utilize any number of components to carry out their intended functions. Furthermore, these devices typically have factory and operator established configuration parameters which define and regulate various performance aspects of the device.

During the service life of a given image forming device such as a printer, declining performance, malfunction, and other events occur which require that the device be serviced. To readily detect a decline in performance or a malfunction of the device, the operating status or performance of various components within the device are usually monitored through the use of corresponding sensors and associated electronics. Some image forming devices provide an indicator light or audible alarm to alert an operator to an “out-of-tolerance” or malfunction condition occurring within a component or components of the device. From time-to-time, a detailed diagnosis of a malfunctioning or under-performing image forming device is required so as to determine the necessary corrective action. Often, such a diagnosis is beyond the technical abilities of the operator of the device, and the assistance of qualified service personnel is required.

In the past, the diagnostic process was typically initiated through the following sequence: 1) a printed diagnostic report of the configuration and sensed operating state of the various components of the device was generated; 2) the device operator gathered the page or pages of the diagnostic report from the image forming device; and 3) the device operator transmitted the diagnostic report to an appropriate service center using facsimile (i.e., Fax).

While this method has been used with a degree of success, a number of problems are common to this technique. For example, the diagnostic report may be faxed to the wrong destination. Further, the diagnostic report may be lost before it can be faxed to an appropriate destination, requiring that it be regenerated. Furthermore, some image forming device malfunctions are such that the diagnostic report itself cannot be printed. Among these and other problems, however, one of the most frequently encountered is that the facsimile image quality at the receiving end (i.e., the service center) is degraded to the point that essential troubleshooting information is not legible to technical service personnel. Often, the overall result of this print-and-fax technique is increased cost, inefficiency, and increased downtime experienced by the user of the image forming device.

The present invention addresses these and other perceived shortcomings in the prior art practices.

### SUMMARY OF THE INVENTION

One aspect of the present invention relates to a printer having a print engine, and a transmission control which is borne by the printer, and which is configured to selectively transmit at least one digital image having information regarding the printer and its operative state to a remote location.

Another aspect of the present invention relates to a printer having a printer chassis with a plurality of components; a plurality of sensors are borne by the chassis and which sense the operative state of the components; detection circuitry is electrically coupled to the individual sensors, and which is configured to generate a status signal corresponding to the operative state of the components; a memory is electrically coupled to the detection circuitry and which is configured to receive and store information regarding the status signal and configuration information of the printer; a digital sender module is electrically coupled with the memory and which is configured to derive at least one digital image for transmission to a remote location; an input/output circuit is provided, and which is electrically coupled to the printer and which is further electrically coupled in selective data communication with a network; a user interface is electrically coupled to the detection circuitry, and which includes at least one signaling indicator which is configured to generate a discernible status signal to an operator to indicate the operative states of the respective components; and a transmission control is provided and which is configured to selectively transmit the at least one digital image to the remote location.

Still another aspect of the invention relates to a printer having a printer chassis with a plurality of components; a plurality of sensors are borne by the printer chassis and which are configured to generate a plurality of sensor signals respectively indicating an operative state of the components of the printer; detection circuitry is borne by the printer chassis and which is electrically coupled to the respective plurality of sensors, and wherein the detection circuitry is configured to generate a plurality of status signals corresponding to the operative state of the respective components of the printer; a memory is borne by the printer chassis and which is electrically coupled to the detection circuitry, and which is configured to receive and store information regarding the status signals provided by the detection circuitry, and configuration information regarding an operative configuration of the printer; a digital sender module is electrically coupled with the memory and which operates to selectively retrieve at least some of the status signal information and at least some of the configuration information from the memory, and which is configured to derive at least one digital image for transmission to a remote location; an input/output circuit is borne by the printer chassis and which couples the printer in data communication with a network, and wherein the input/output circuit is electrically coupled to the memory and the digital sender module; a user interface is borne by the printer chassis and which is electrically coupled to the detection circuitry, and which further includes at least one signaling indicator which is configured to generate a status indication to an operator to identify the current operational condition of the components of the printer; and a transmission control is borne by the printer chassis and which is electrically coupled to the digital sender module, and which is configured to selectively transmit the at least one digital image to the remote location.

Another aspect of the invention relates to a method of operating a printer including providing a plurality of components borne by a printer chassis, and wherein the printer has a configuration; sensing the operative states of the respective components; generating status signals corresponding to the operative states of the respective components; receiving and storing information regarding the status signals and configuration of the printer; deriving at least one digital image from the status signals and configuration information for transmission to a location remote from the printer; and transmitting the at least one digital image to the remote location by way of a network.

Yet another aspect of the invention relates to a method of operating a printer including providing a plurality of printer components and which includes a user interface, a memory, and a transmission control; providing an operator-discernible signal borne by the user interface and which alerts an operator to an operational condition of the respective components, and wherein the operational condition is stored as information in the memory; activating the transmission control to transmit the information stored in the memory to a remote location; providing a digital sender module which is electrically coupled with the memory and which, in response to the activation of the transmission control, derives a digital image from at least some of the information stored in the memory; and sending the digital image by way of a network to the remote location.

Yet still another aspect of the invention relates to a printer having a plurality of components borne by a printer chassis, and wherein the printer has a configuration; means for providing a status signal corresponding to an operative state of the respective components; means for providing an operator-discernible signal and which alerts an operator to the operative state of the respective components; means for receiving and storing information regarding the status signal and configuration; means for deriving a digital image which corresponds to at least some of the stored information for transmission to a remote location; means for coupling the printer in data communication with a network; and means for causing the transmission of the digital image to the remote location by way of the network.

### DESCRIPTION OF THE DRAWINGS

FIG. 1 is a block diagram showing the cooperative relationship of components of one embodiment of the present invention.

FIG. 2 is a block diagram of elements of a printer of one embodiment of the present invention.

FIG. 3 is a flowchart of the logic sequence of one embodiment of the present invention.

FIG. 4 is an exemplary configuration report image of one embodiment of the present invention.

### DETAILED DESCRIPTION OF THE INVENTION

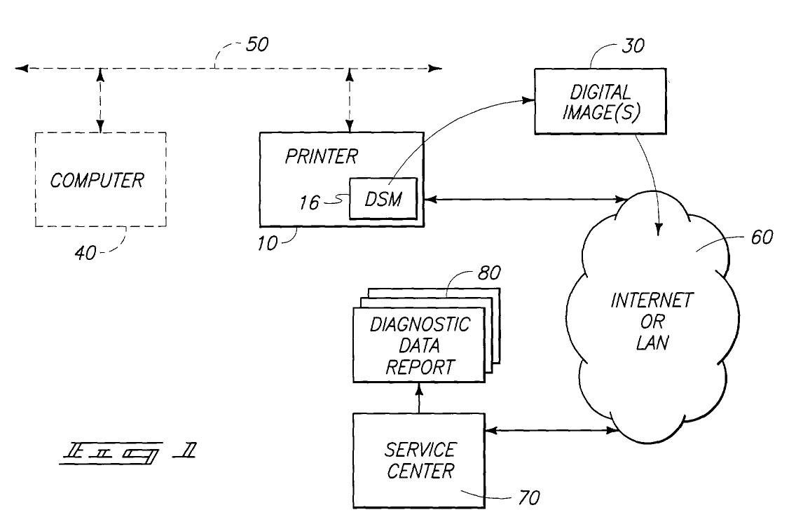

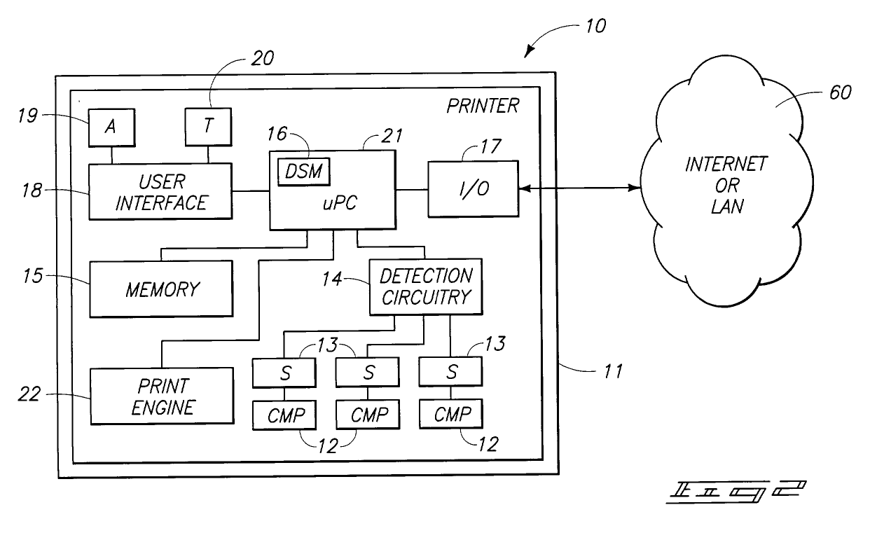

Referring now to FIGS. 1 and 2, an image forming device (i.e., printer) 10 is shown in schematic representation. While this illustration is indicative of a laser-type printer, it should be understood that the invention is not so limited and is applicable to other image forming devices such as facsimile machines, thermal printers, impact printers, inkjet printers, and virtually any other kind of image forming device which uses a variety of components so as to create printed images. The laser printer example has been adopted for the sake of convenience and understanding only. Hence any references to a laser printer, printing device or other specific printer references are intended to refer and apply to the broad category of image forming devices which employ a variety of components to render images.

Printer 10 includes a chassis 11, which encloses or otherwise mounts a plurality of components 12 which facilitate the proper operation of the printer 10. In this regard, the various components 12 of the printer 10 may include assorted components such as a print engine; a formatter; and consumables such as a supply of toner and paper as needed to carry out the print functions of the printer 10. Further elaboration regarding these components is not necessary to an understanding of the present invention.

The printer 10 further includes a plurality of sensors 13 which are borne by the printer chassis 11 and which provide a corresponding plurality of signals respectfully indicating or revealing the operative state of the various components 12 of the printer 10. The operative state of components 12 includes, for example, such physical characteristics as the temperature of certain components 12; rotational speed or velocity of moving components 12; and the available amount of a consumable resource such as toner or paper, etc. The detection of other physical characteristics corresponding to the respective components 12 operative state are of course possible. The present sensors are individually operable to sense steady-state, failure, and declining performance of the respective components 12. The printer 10 also includes detection circuitry 14 which is borne by the printer chassis 11, and which is electrically coupled to the individual sensors 13. The detection circuitry 14 provides a plurality of status signals which correspond to the operative state of the respective components 12 of the printer 10, as sensed by the sensors 13.

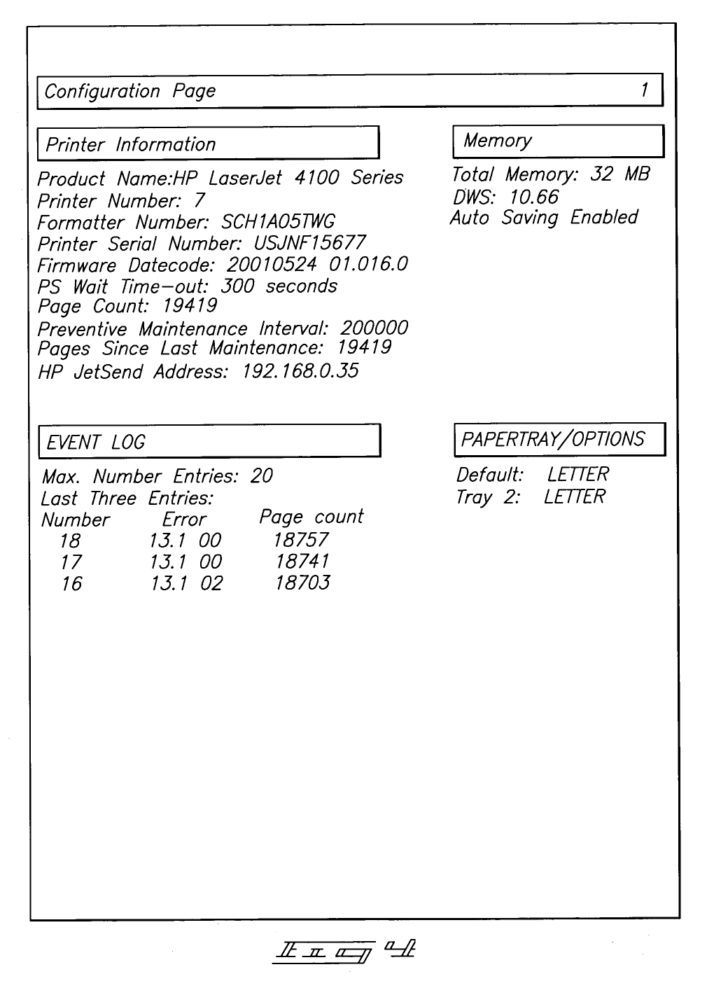

The printer 10 also includes a memory 15 which is borne by the printer chassis 11, and which is electrically coupled to the detection circuitry 14. The memory 15 receives and stores information regarding the status signals provided by the detection circuitry 14, and further stores configuration information regarding both factory and user established configurations of the printer 10. Such configuration information may include, for example, available or optionally installed fonts; total memory capacity; preventive maintenance intervals; version of installed firmware; etc. Other kinds of configuration information are of course possible. An example of the type of configuration information available can be seen through a study of FIG. 4.

The printer 10 further includes a digital sender module 16 which is electrically coupled with the memory 15 and which operates to selectively retrieve at least some of the status signal information and at least some of the configuration information from the memory 15. The digital sender module 16 is normally implemented in printer 10 firmware (not shown) and which is part of a controller 21, which will be discussed in greater detail hereafter. The digital sender module 16 further uses the information retrieved from memory 15 to derive at least one digital image 30 (FIG. 1) for transmission to a remote location 70. As shown, the remote location 70 is represented as a service center. Other destinations for this digital image 30 are of course also possible. In any case, the digital image 30 serves to convey the present status signal(s) (i.e., operative states of components 12) and printer 10 configuration information to the remote location 70.

The printer 10 further includes an input/output circuit 17 (FIG. 2) borne by the printer chassis 11, and which couples the printer 10 in data communication with a network or the Internet 60 as seen in FIG. 1. The input/output circuit 17 is electrically coupled to the memory 15 and the digital sender module 16. As seen in FIG. 2, the printer 10 also includes a user interface 18 which is borne by the printer chassis 11. The user interface 18 is electrically coupled to the detection circuitry 14, and includes at least one signaling indicator 19, which provides a status indication to an operator so as to convey the current operational state or condition of the components 12 of the printer 10. This signaling indicator 19 may provide visual and/or other audible cues to an operator of the device 10.

The printer 10 further includes a transmission control 20 which is borne by the printer chassis 11, and which is electrically coupled to the user interface 18 and the digital sender module 16. The transmission control 20 permits an operator to selectively transmit the digital image 30 to the remote location 70. As will be recognized by a study of FIG. 1, the digital image 30 may be converted into a diagnostic data report 80 at the remote location 70. As earlier discussed, FIG. 4 shows the type of information which may be generated in these reports 80.

The printer 10 further includes a controller (uPC) 21, which is borne by the printer chassis 11, and which is electrically coupled to the previously described elements as needed so as to control the overall operation and performance of the printer 10. The controller 21 typically comprises a microprocessor or a microcontroller, in addition to other support electronics as needed to carry out the various control functions of the printer 10. As further seen in FIG. 2, a print engine 22 is provided and which is electrically coupled with the controller 21. As seen in FIG. 1, the printer 10 is electrically coupled to a computer 40 by way of an electrical pathway 50. The computer, of course, provides input data to the printer 10 for appropriate processing into a suitable document (not shown).

The input/output circuit 17 of the printer 10 operates to provide selective data communication between the printer 10 and a network or the Internet 60. Such data communication typically includes the transmission of the digital image 30 to the remote location 70 by way of the network or Internet 60. Other kinds of data communication using the input/output circuit 17 are also possible. Furthermore, the digital sender module 16 of the printer 10 operates to format the digital image 30 for transmission over the network or Internet 60. Such formatting typically includes providing the digital image 30 with routing and other information as needed to facilitate transmission by way of the network or Internet 60.

The printer 10 may optionally include a user operable control (not shown) which permits the printer 10 to generate a printed report corresponding to the digital image 30. An example of such a printed report is typified by FIG. 4. In one embodiment, such a user operable control is made integral with the user interface 18. Other embodiments of printer 10 having other forms of a user operable control are also possible. Furthermore, the transmission control 20 may be made integral with the user interface 18. Optionally, the transmission control 20 may be remotely located relative to the user interface 18. Other forms of incorporating the transmission control 20 with the printer 10 are also possible.

One possible method of operating the printer 10 which includes a plurality of components 12 and which are borne by the printer chassis 11 is set forth below. In this regard, the printer 10 is provided with a factory and/or user established configuration. The operative states of the respective components 12 are sensed using the sensors 13, in conjunction with the detection circuitry 14. Status signals corresponding to the operative states of the respective components 12 are generated by the detection circuitry 14. Following the step of sensing, the information regarding the status signals and the configuration of the printer 10 is received and stored within the memory 15.

At least some of the status signal and configuration information is then selectively gathered from the memory 15, and used by the digital sender module 16 to derive the digital image 30. Finally, the digital image 30 is transmitted to the remote location 70 by way of a network or the Internet 60, in response to a request to transmit being received at the printer 10 by way of the transmission control 20.

Another possible method of operating the printer 10 which includes a plurality of printer components 12 is noted below. A user interface 18; a memory 15; and a transmission control 20 are provided and are borne by the chassis 11 of the printer 10. An operator-discernible signal is provided by way of a signaling indicator 19 which is borne by the user interface 18, and which alerts an operator to an operational condition of the respective components 12. This operational condition information is stored within the memory 15. In response to a particular operational condition signal provided by the indicator 19, an operator activates the transmission control 20 so as to initiate transmission of at least some of the information stored in the memory 15 to a remote location 70. A digital sender module 16 has been provided with the printer 10, and is electrically coupled with the memory 15. The digital sender module 16, in response to the activation of the transmission control 20, derives a digital image 30 from at least some of the operational condition information stored within the memory 15. The printer 10 then utilizes the digital sender module 16 to send the digital image 30 to the remote location 70 by way of a network or the Internet 60.

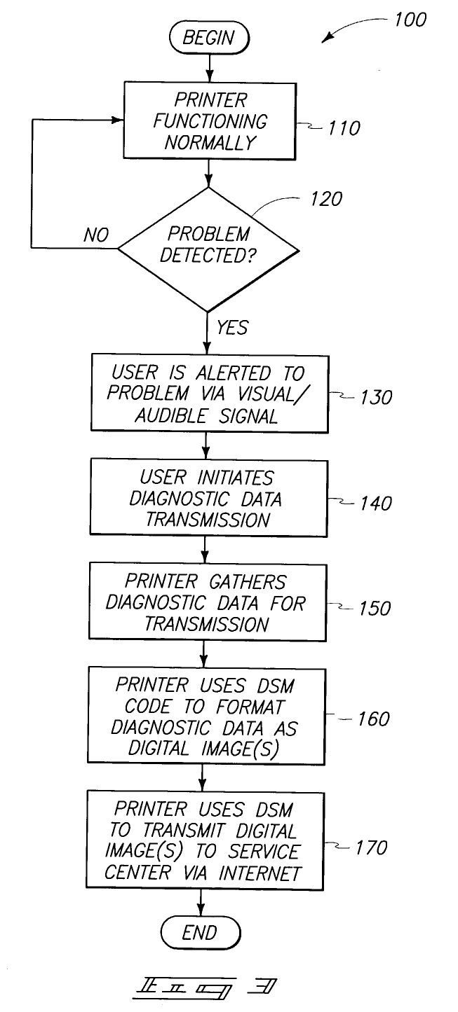

FIG. 3 represents the typical operational sequence of the printer 10, and which is generally indicated as numeral 100.

In step 110 of sequence 100, the printer 10 is functioning normally.

In step 120, the sensors 13 and the detection circuitry 14 serve to monitor the operational status of the components 12 of the printer 10, and to determine if normal or abnormal operation is presently detected.

In step 130, it is assumed that the sensors 13 and the detection circuitry 14 have detected a problem regarding a component or components 12 within the printer 10, and that a corresponding status signal has been generated. In response to this status signal, the signaling indicator 19 alerts a user to the detected problem by way of visual and/or audible signals.

In step 140, the user initiates transmission of at least some operational condition and configuration information of the printer 10 (collectively known as diagnostic data), by use of the transmission control 20.

In step 150, the printer 10 gathers at least some operating condition and configuration information from the memory 15.

In step 160, the printer 10 uses computer readable code within the digital sender module 16 to derive at least one digital image 30 (FIG. 1) from the information gathered from the memory 15, and formats the digital image 30 for transmission by way of a network or the Internet 60.

Finally, in step 170, the printer 10 uses the digital sender module 16 and the input/output circuit 17 to transmit the at least one digital image 30 to the remote location (i.e, a service center) 70 by way of the network 60. The digital image or images 30 are then typically printed in the form of the diagnostic data report 80 at the remote location 70, an example of which is shown in FIG. 4.

Therefore, it will be seen that the present invention provides a convenient and effective means by which diagnostic data may be transmitted to a remote location for various purposes, while avoiding the many shortcomings and difficulties encountered with the prior art practices.

In compliance with the statute, the invention has been described in language more or less specific as to structural and methodical features. It is understood, however, that the invention is not limited to the specific features shown and described, since the means herein disclosed comprise forms of putting the invention into effect. The invention is, therefore, claimed in any of its forms or modifications within the proper scope of the appended claims appropriately interpreted in accordance with the doctrine of equivalents.

What is claimed is:

1. A printer comprising:
a print engine;
a controller electrically coupled with the print engine; and
a transmission control borne by the printer and which is configured to selectively transmit at least one digital image having information regarding the printer and its operative state to a remote location.

2. A printer in accordance with claim 1, and wherein the information regarding the printer includes a configuration of the printer.

3. A printer in accordance with claim 1, and wherein the information regarding the operative state includes an out-of-tolerance condition.

4. A printer in accordance with claim 1, and wherein the information regarding the operative state includes a declining performance condition.

5. A printer in accordance with claim 1, and wherein the printer includes at least one component, and a sensor electrically coupled in sensing relation relative to the component to detect the operative state of the component.

6. A printer in accordance with claim 1, and wherein the printer includes at least one component, and a sensor electrically coupled in sensing relation relative to the component to detect a declining performance of the component.

7. A printer in accordance with claim 1, and further comprising:
a sensor borne by the printer for detecting the operative state of the printer; and
detecting circuitry electrically coupled to the sensor and configured to generate a status signal corresponding to the operative state.

8. A printer in accordance with claim 1, and wherein the printer generates operative state information and information regarding a configuration of the printer, and wherein the printer further has a memory which is configured to store the operative state and configuration information.

9. A printer in accordance with claim 1, and further comprising:
a memory; and
a digital sender module electrically coupled with the memory and which is configured to derive the at least one digital image, and wherein the at least one digital image is formatted for a network transmission.

10. A printer in accordance with claim 1, and further comprising:
input output circuitry which is electrically coupled with the printer and which is further coupled in selective data communication with a network.

11. A printer in accordance with claim 1, and wherein the transmission control comprises a user-operable control which is configured to transmit the at least one digital image to the remote location by way of a network.

12. A printer in accordance with claim 1, and further comprising:
a user interface borne by the printer and which is configured to indicate the operative state.

13. A printer in accordance with claim 1, and further comprising:
a user-operable control which causes the printer to generate a printed report corresponding to the at least one digital image.

14. A printer comprising:
a printer chassis;
a plurality of components, including a print engine, borne by the chassis;
a plurality of sensors which are configured to sense the operative state of the components;
detection circuitry electrically coupled to the individual sensors, and which generates a status signal corresponding to the operative state of the components;
a memory which is electrically coupled to the detection circuitry, and which is configured to receive and store information regarding the status signal and configuration information of the printer;
a digital sender module electrically coupled with the memory and which is configured to derive at least one digital image for transmission to a remote location;
an input output circuit which is electrically coupled to the printer and in selective data communication with a network;
a user interface which is electrically coupled to the detection circuitry, and which includes at least one signaling indicator which is configured to generate a discernable status signal to an operator to indicate the operational states of the respective components; and
a transmission control which is configured to selectively transmit the at least one digital image to the remote location.

15. A printer in accordance with claim 14, and wherein the user interface is configured to selectively generate a printed report corresponding to the at least one digital image.

16. A printer in accordance with claim 14, and wherein the digital sender module is configured to derive the at least one digital image from the configuration information which is stored in the memory.

17. A printer in accordance with claim 14, and wherein the digital sender module is configured to derive the at least one digital image from the status signal derived from the respective sensors, and which is stored in the memory.

18. A printer in accordance with claim 14, and wherein the transmission control is made integral with the user interface.

19. A printer in accordance with claim 14, and wherein the transmission control is located remotely relative to the user interface.

20. A printer in accordance with claim 14, and wherein the transmission control is configured to selectively transmit the configuration information and the status signal information derived from the respective sensors to the remote location.

21. A printer in accordance with claim 14, and wherein the transmission control is configured to selectively transmit the configuration information and the status signal information derived from the respective sensors and which further includes declining performance and unchanged performance conditions for the respective components to the remote location.

22. A printer comprising:
a printer chassis having a plurality of components which are borne by the chassis;
a plurality of sensors borne by the printer chassis and which are configured to generate a plurality of sensor signals respectively indicating an operative state of the components of the printer;
detection circuitry borne by the printer chassis and which is electrically coupled to the respective plurality of sensors, and wherein the detection circuitry is configured to generate a plurality of status signals corresponding to the operative state of the respective components of the printer;
a memory borne by the printer chassis and which is electrically coupled to the detection circuitry, and which is configured to receive and store information regarding the status signals provided by the detection circuitry, and configuration information regarding an operative configuration of the printer;
a digital sender module electrically coupled with the memory and which is configured to selectively retrieve at least some of the status signal information and at least some of the configuration information from the memory, and to derive at least one digital image for transmission to a remote location;
an input output circuit borne by the printer chassis and which couples the printer in data communication with a network, the input output circuitry being electrically coupled to the memory and the digital sender module;
a user interface borne by the printer chassis and which is electrically coupled to the detection circuitry, and including at least one signaling indicator which is configured to generate a status indication to an operator to indicate the current operational condition of the components of the printer; and
a transmission control borne by the printer chassis and which is electrically coupled to the digital sender module, and which is configured to selectively transmit the at least one digital image to the remote location.

23. A printer in accordance with claim 22, and wherein the at least one digital image includes the status signal information which is retrieved from the memory, and wherein the status signal information includes both declining and unchanged performance conditions of the respective components.

24. A printer in accordance with claim 22, and wherein the at least one digital image includes the configuration information which is retrieved from the memory, and wherein the configuration information includes both a factory and an operator established configuration for the printer.

25. A printer in accordance with claim 22, and wherein the at least one digital image includes the configuration and the status signal information which is retrieved from the memory, and wherein the configuration and status signal information includes both a factory and an operator established configuration for the printer, and declining and unchanged performance conditions for the respective components.

26. A method of operating a printer comprising:
providing a plurality of components borne by a printer chassis and wherein the printer has a configuration;
sensing the operative states of the respective components;
generating status signals corresponding to the operative states of the respective components;
receiving and storing information regarding the status signals and configuration of the printer;
deriving at least one digital image from the status signals and configuration information for transmission to a location remote from the printer; and
transmitting the at least one digital image to the remote location, by way of a network, in response to a transmit request being received at the printer from a user.

27. A method of operating a printer comprising:
providing a plurality of printer components and which include a user interface, a memory and a transmission control;
providing an operator-discernable signal borne by the user interface and which alerts an operator to an operational condition of the respective components, and wherein the operational condition is stored as information in the memory;
activating the transmission control to transmit the information stored in the memory to a remote location;
providing a digital sender module which is electrically coupled with the memory and which, in response to the activation of the transmission control, derives a digital image from at least some of the information stored in the memory; and
sending the digital image by way of a network to the remote location.

28. A printer comprising:
a plurality of components borne by a printer chassis, and wherein the printer has a configuration;
means for providing a status signal corresponding to an operative state of the respective components;
means for providing an operator-discernable signal and which alerts an operator to the operative state of the respective components;
means for receiving and storing information regarding the status signal and configuration;
means for deriving a digital image which corresponds to at least some of the stored information for transmission to a remote location;
means for coupling the printer in data communication with a network; and
means for causing the transmission of the digital image to the remote location by way of the network.

29. A computer readable media bearing computer programming that, when loaded into a computer, causes the computer to implement a method of operating a printer which has a plurality of components and a printer configuration, the method comprising:
sensing the operative states of the respective components;
generating status signals corresponding to the operative states of the respective components;
receiving and storing information regarding the status signals and configuration of the printer;
deriving at least one digital image from the status signals and configuration information for transmission to a location remote from the printer; and
transmitting the at least one digital image to the remote location, by way of a network, in response to a transmit request being received at the printer from a user.
